(19) United States
(12) Patent Application Publication
(10) Pub. No.: US 2026/0063236 A1
(43) Pub. Date: Mar. 5, 2026

(54) VACUUM-INSULATED TRANSPORT PIPE DEVICE AND PIPELINE TRANSPORT SYSTEM

(71) Applicant: DIRECTLY TECHNOLOGY CO., LTD., Hsinchu City (TW)

(72) Inventor: Shih-Hao TANG, Hsinchu City (TW)

(21) Appl. No.: 18/816,035

(22) Filed: Aug. 27, 2024

(51) Int. Cl. F16L 59/065; H05B 1/02

(52) U.S. Cl. CPC F16L 59/065; H05B 1/0291

(57) ABSTRACT

Disclosed is a vacuum-insulated transport pipe device and a pipeline transport system. The system includes two transport pipe devices, a pump, and a control unit. Each transport pipe device includes an inner pipe, an outer pipe, and an electric heating structure. The inner pipe is disposed inside the outer pipe to form a closed chamber therebetween, and the electric heating structure surrounds the inner pipe, with each inner pipe being connected and communicating with each other. The pump draws air from the chamber to form a vacuum state. The control unit controls the operation of each electric heating structure and the pump to reduce heat transfer through the outer pipe. This allows the inner pipe to easily maintain a preset temperature, reducing the energy consumption of the electric heating structure.

### CROSS-REFERENCE TO RELATED APPLICATIONS

Not applicable.

### BACKGROUND OF THE INVENTION

The present invention relates to the field of electrical thermal insulation for pipes used to transport flowable substances. In particular, the present invention relates to a vacuum-insulated transport pipe device and a pipeline transport system.

In order to meet the particular needs in transporting certain materials, the pipelines conveying such materials must be maintained within a certain temperature range. Apart from heat insulation means to reduce the loss of thermal energy, timely heat replenishment is necessary to maintain the temperature of the pipelines. Therefore, a special kind of electric heat-insulating device for pipelines was produced.

The conventional electric heat-insulating device for pipelines comprises an outer covering skin, an insulation layer, and a heating device, wherein, the outer covering skin comprises an inner sidewall, an outer sidewall and a holding space. The holding space is located between the inner sidewall and the outer sidewall, the inner sidewall covers a pipeline, and the insulation layer is configured in the holding space. The insulation layer comprises an aerogel felt and a thin film that covers the aerogel felt. The heating device is configured in the holding space, and has an electric heating board. The electric heating board clings to the inner sidewall, and is mainly made of a heat-insulating substrate arranged with an electric circuit. Based on the impedance characteristic of the electric circuit, when electric current passes through the electric circuit, the electric circuit will generate thermal energy to heat up the pipeline.

Based on the length or shape of the pipeline, a plurality of the above-mentioned electric heat-insulating devices are deployed sequentially along the pipeline. The electric heating boards of the electric heat-insulating devices are usually connected in series to simplify the overall circuit arrangement. However, the problem is, in the case of overheat breakage or shortcut of any of the electric circuits in the electric heating boards or of the wires electrically connected to the electric circuits, none of the electric heating boards can continue to supply thermal energy. When there are a large number of electric heat-insulating devices, examining, repairing or replacing the failing component can be very difficult. Moreover, as the overheat breakage or shortcut occurs in the electric circuit, which is very close to the pipeline, it may cause breakage of the pipeline or affect the strength or durability of the pipeline. This is a safety problem to be considered.

### SUMMARY OF THE INVENTION

The main purpose of this invention is to provide a vacuum-insulated transport pipe device and a pipeline transport system.

To achieve the above purpose, this invention employs the following technical solution:

A vacuum-insulated transport pipe device is provided, including an inner pipe, an outer pipe, and an electric heating structure, wherein the inner pipe is used for transporting flowable substances and the outer pipe forms a chamber. The inner pipe is disposed within the chamber, and two closure structures respectively seal both ends of the chamber along the axis of the outer pipe, with the inner pipe passing through each closure structure and extending to the outside of the outer pipe. A one-way valve is installed on the outer pipe and communicates with the chamber. The electric heating structure is disposed within the chamber and circumferentially surrounds the inner pipe, and a space is formed between the electric heating structure and a wall of the outer pipe on the side facing the chamber. The outer pipe forms an installation hole connecting the chamber and the outer periphery of the outer pipe. An electrical connection port is installed in the installation hole and forms an airtight bond with the outer pipe. The electric heating structure is electrically connected to the electrical connection port.

A temperature sensor and a pressure sensor are respectively configured in the chamber, and the temperature sensor and the pressure sensor are respectively electrically connected to the electrical connection port. Wherein the temperature sensor is connected to the inner pipe for sensing the temperature of the inner pipe, and the pressure sensor is used for sensing the air pressure in the chamber.

A pipeline transport system is provided, including two transport pipe devices, a connection structure, a vacuum pipe, a pump, and a control unit, wherein each of the transport pipe devices is a vacuum-insulated transport pipe device as described above. The transport pipe devices are arranged in sequence, the connection structure connects the adjacent inner pipes, the vacuum pipe connects each one-way valve and the pump, and the pump draws air from the interior of each chamber through the vacuum pipe.

The control unit primarily comprises electronic circuits, including two controllers, two temperature sensors, and two pressure sensors, wherein each transport pipe device is correspondingly configured with one controller. Each controller is electrically connected to the electrical connection port and the one-way valve of its corresponding transport pipe device. Each temperature sensor senses the temperature of each inner pipe and transmits the sensed temperature data to the respective controller and each pressure sensor senses the air pressure in each chamber and transmits the pressure data to the respective controller. Each controller includes a microprocessor executing an application program, based thereon. Each microprocessor controls the operating state of each electric heating structure and the pump, and the communication or blocking of each one-way valve based on the temperature data and the pressure data.

The vacuum state of each chamber can reduce the transfer of heat energy from the inner pipe and each electric heating structure to the outside through each outer pipe, making it easier for the inner pipe to maintain a preset temperature and reducing the electric energy consumption required for each electric heating structure to maintain the temperature of each inner pipe by heating.

### BRIEF DESCRIPTION OF DRAWINGS

FIG. 1 is a sectional view of the transport pipe device of a preferred embodiment of this invention.

FIG. 2 is a partial enlarged view of FIG. 1.

FIG. 3 is a partial system architecture diagram of a preferred embodiment of this invention.

FIG. 4 is a partial sectional schematic diagram of a preferred embodiment of this invention, showing the part where the connection structure connects adjacent transport pipe devices.

FIG. 5 is a circuit block diagram of a preferred embodiment of this invention.

### DETAILED DESCRIPTION OF THE INVENTION

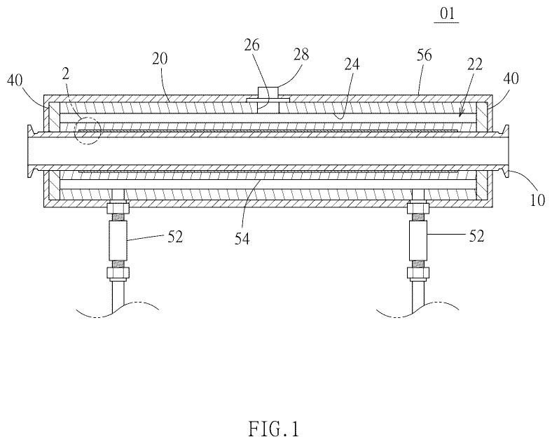

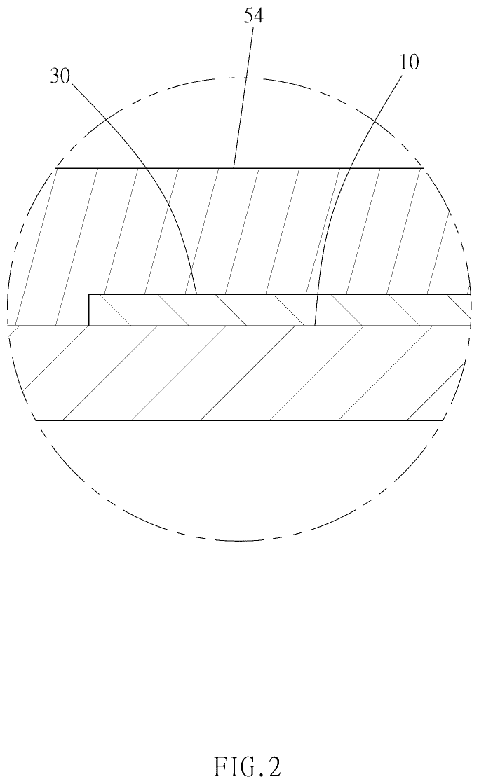

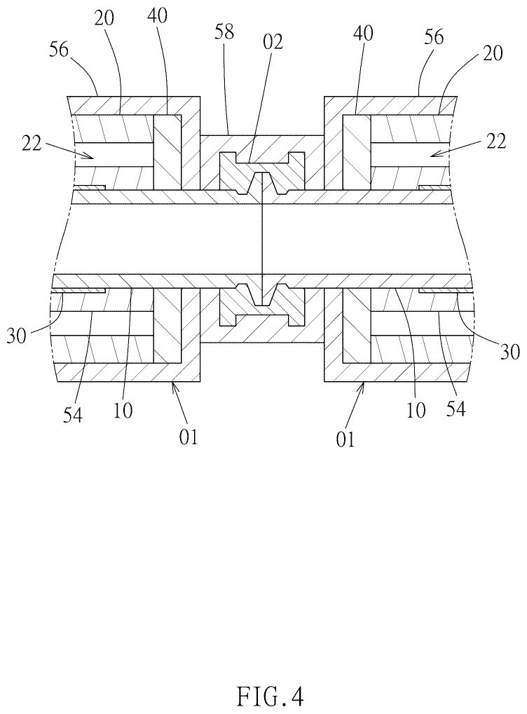

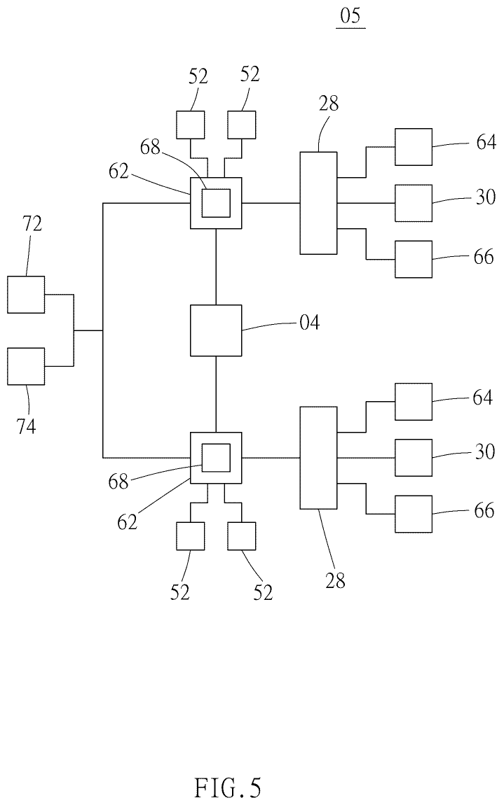

As shown in FIGS. 1 to 5, a preferred embodiment of a pipeline transport system of this invention includes multiple transport pipe devices 01, a connection structure 02, a vacuum pipe 03, a pump 04, and a control unit 05. Each transport pipe device 01 is a vacuum-insulated transport pipe device, including an inner pipe 10, an outer pipe 20, and an electric heating structure 30. Each inner pipe 10 is used for transporting flowable substances (not shown), each outer pipe 20 forms an inner chamber 22, and each inner pipe 10 is disposed within each chamber 22. Multiple closure structures 40 each seal both ends of each chamber 22 along the axis of each outer pipe 20, and each closure structure 40 is connected to each outer pipe 20. Both axial ends of each inner pipe 10 pass through each closure structure 40 and extend to the outside of each outer pipe 20.

Each inner pipe 10, outer pipe 20, and closure structure 40 are made of metallic materials, and each inner pipe 10 and outer pipe 20 are joined to the respective closure structures 40 by welding, thus forming a rigid structure that can withstand air pressure without deformation.

The transport pipe devices 01 are arranged in sequence, with the inner pipes 10 axially aligned. The connection structure 02 connects the adjacent inner pipes 10, allowing the axially adjacent inner pipes 10 to communicate. One inner pipe 10 is connected to a source of the substance (not shown), while another inner pipe 10 is connected to external equipment (not shown), allowing the substance to flow sequentially through each inner pipe 10 from the source into the equipment.

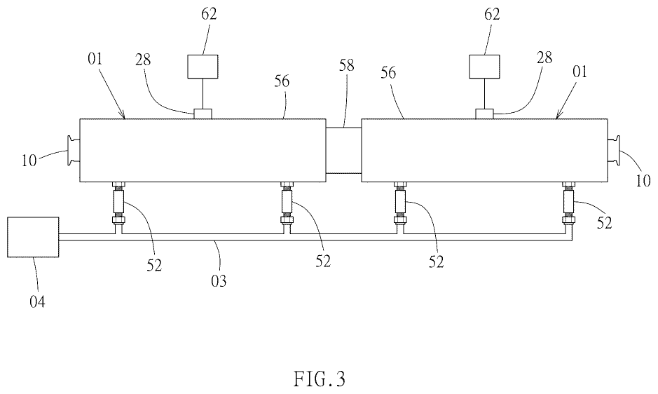

FIG. 3 shows that a preferred embodiment has at least two transport pipe devices 01, but this should not be interpreted as limiting the number of transport pipe devices 01 in the pipeline transport system to only two. The number of connection structures 02 varies with the number of transport pipe devices 01, ensuring that every two axially adjacent inner pipes 10 are connected by one connection structure 02.

Multiple one-way valves 52 are installed on each outer pipe 20 and communicate with each chamber 22, and each outer pipe 20 has at least one one-way valve 52. In this embodiment, each outer pipe 20 has two one-way valves 52. The vacuum pipe 03 connects each one-way valve 52 to the pump 04. The pump 04 draws air from the interior of each chamber 22 through the vacuum pipe 03, thereby creating a vacuum condition in each chamber 22.

Each one-way valve 52 is used to control the air flow to allow the air to flow only from each chamber 22 to the vacuum pipe 03, while preventing air from entering each chamber 22 through the one-way valves 52. Each one-way valve 52 can be selected to be in an open or closed state as needed, and the pump 04 can draw air from the one or more chambers 22 through the one or more open one-way valves 52, but cannot draw air from the one or more chambers 22 through the one or more closed one-way valves 52.

Each electric heating structure 30 is disposed in each chamber 22 and circumferentially surrounds the exterior of each inner pipe 10, and a space is formed between each electric heating structure 30 and a wall 24 of each outer pipe 20 on the side facing the chamber 22 where each electric heating structure 30 does not contact each wall 24, thereby preventing heat transfer from each electric heating structure 30 to each outer pipe 20 by contact conduction. Wherein each electric heating structure 30 is mainly composed of at least one electric heating plate (not shown).

Each outer pipe 20 forms an installation hole 26 connecting each chamber 22 and the outer periphery of each outer pipe 20. Two electrical connection ports 28 are installed in each installation hole 26 and form an airtight bond with each outer pipe 20, thus preventing air from entering each chamber 22 through the space between each electrical connection port 28 and each installation hole 26. Wherein each electric heating structure 30 is electrically connected to each electrical connection port 28.

The connection structure 02, each one-way valve 52, each electric heating structure 30, and each electrical connection port 28 are existing technologies familiar to those skilled in the art of this invention, so their specific compositions will not be described in detail.

The control unit 05 consists primarily of electronic circuits, including two controllers 62, multiple temperature sensors 64, and multiple pressure sensors 66. Each controller 62 is electrically connected to each electrical connection port 28, each temperature sensor 64 is connected to each inner pipe 10, and each pressure sensor 66 is disposed in each chamber 22. Each transport pipe device 01 corresponds to one electrical connection port 28 and one controller 62. Each controller 62 is electrically connected to the electrical connection port 28 and the one-way valve 52 of each corresponding transport pipe device 01. Each transport pipe device 01 is configured with at least one temperature sensor 64 and at least one pressure sensor 66.

Each temperature sensor 64 and each pressure sensor 66 is electrically connected to each electrical connection port 28. Each temperature sensor 64 senses the temperature of each inner pipe 10 and transmits the sensed temperature data to the respective controllers 62 through each electrical connection port 28. Each pressure sensor 66 senses the air pressure in each chamber 22 and transmits the sensed pressure data to the respective controllers 62 through each electrical connection port 28. Each controller 62 includes a microprocessor 68 that executes an application program. Based thereon, each microprocessor 68 controls the operating state of each electric heating structure 30 and the pump 04, and the communication or blocking of each one-way valve 52 based on the temperature data and the pressure data.

Each controller 62 receives the temperature data and the pressure data. After comparison, each microprocessor 68 determines the difference between the temperature data and the pressure data relative to a preset temperature and a preset pressure, respectively. It then selects to control the respective electric heating structures 30, the pump 04, and the respective one-way valves 52 to ensure that the respective inner pipes 10 can maintain the preset temperature and the respective chambers 22 can maintain a vacuum state. The vacuum state refers to the condition in which the air pressure in each chamber 22 is less than atmospheric pressure, but does not necessarily require the air pressure in each chamber 22 to be zero.

The control unit 05 controls the mode of the pump 04, including whether the pump 04 operates and the output power when operating.

The vacuum state of each chamber 22 can reduce the transfer of heat energy from the inner pipe 10 and each electric heating structure 30 to the outside through each outer pipe 20, making it easier for the inner pipe 10 to maintain the preset temperature and reducing the electrical energy consumption required for each electric heating structure 30 to maintain the temperature of each inner pipe 10 by heating.

If the electric heating structure 30 configured in a particular transport pipe device 01 fails to operate normally, or if an outer pipe 20 or closure structure 40 cracks, allowing outside air to enter the chamber 22 within the outer pipe 20, the transport pipe device 01 can be selectively removed for inspection, repair, or replacement. At this time, the controllers 62 configured for the other non-removed transport pipe devices 01 can still control the communication or blocking of the respective one-way valves 52 to allow the chambers 22 within the non-removed transport pipe devices 01 to continuously maintain the vacuum state and the respective inner pipes 10 to continuously maintain the preset temperature. After the removed transport pipe device 01 is repaired or replaced with a new one, the pump 04 only needs to operate to draw air from the chamber 22 within the repaired or replaced transport pipe device 01 to reduce its air pressure to the vacuum state, and the control unit 05 only needs to control the respective electric heating structure 30 to generate heat to heat the inner pipe 10 and return to the preset temperature. Therefore, the repair or replacement of the transport pipe device 01 is easy to perform, and after the repair or replacement is completed, the preferred embodiment requires less time to resume operation and consumes less overall electric power.

Each transport pipe device 01 further includes a first insulation blanket 54 and a second insulation blanket 56. Each first insulation blanket 54 and each second insulation blanket 56 are made of aerogel composite nanomaterials with thermal insulation properties. Each first insulation blanket 54 is disposed in the chamber 22 circumferentially surrounding the exterior of each electric heating structure 30 and each inner pipe 10, forming a space from each wall 24, ensuring that each first insulation blanket 54 does not contact the outer pipe 20, thereby avoiding heat transfer to each outer pipe 20 through contact conduction. Each second insulation blanket 56 covers the exterior of each outer pipe 20 and each closure structure 40, thereby reducing heat dissipation to the exterior through each outer pipe 20 and each closure structure 40.

The exterior of the connection structure 02 is covered with an insulating member 58 to reduce heat dissipation to the exterior through the connection structure 02.

The control unit 05 further includes a display 72 and an operating device 74. The display 72 and the operating device 74 are respectively coupled to each controller 62. The display 72 is used to display the temperature data and the pressure data, and the operating device 74 is mainly composed of electronic circuits and is used to operate and control each controller 62.

Each controller 62 transmits the temperature data and pressure data of its configured transport pipe devices 01 to the display 72, allowing management and maintenance personnel to remotely monitor each transport pipe device 01 through the display 72. This enables them to detect abnormalities and identify in which transport pipe device 01 the abnormality is occurring in, thereby facilitating timely inspection, repair, or replacement of the abnormal transport pipe device 01 or pump 04 by management and maintenance personnel, which is conducive to improving the efficiency of system maintenance and repair.

With the installation of the operating device 74, system management and maintenance personnel can timely switch to a manual operation mode based on whether the operation of each component is abnormal and the need for maintenance and updating of hardware components, upgrading or updating of the application program, or other requirements. This allows them to replace the control of the selected controller(s) 62 over corresponding transport pipe devices 01 or pumps 04 with a higher system management authority. Meanwhile, system management and maintenance personnel may also operate the operating device 74 to change the set temperature and pressure.

1. A vacuum-insulated transport pipe device, including an inner pipe, an outer pipe, and an electric heating structure, wherein the inner pipe is used for transporting flowable substances and the outer pipe forms a chamber; the inner pipe is disposed within the chamber, two closure structures respectively seal both ends of the chamber along the axis of the outer pipe, and the inner pipe passes through each closure structure and extends to the outside of the outer pipe;
a one-way valve is installed on the outer pipe and communicates with the chamber; the electric heating structure is disposed within the chamber and circumferentially surrounds the inner pipe, and a space is formed between the electric heating structure and a wall of the outer pipe on the side facing the chamber; the outer pipe forms an installation hole connecting the chamber and the outer periphery of the outer pipe, an electrical connection port is installed in the installation hole and forms an airtight bond with the outer pipe; the electric heating structure is electrically connected to the electrical connection port; a temperature sensor and a pressure sensor are respectively configured in the chamber, and the temperature sensor and the pressure sensor are respectively electrically connected to the electrical connection port, wherein the temperature sensor is connected to the inner pipe for sensing the temperature of the inner pipe, and the pressure sensor is used for sensing the air pressure in the chamber.

2. The vacuum-insulated transport pipe device according to claim 1, further including a first insulation blanket disposed within the chamber, wherein the first insulation blanket circumferentially surrounds the exterior of the electric heating structure and the inner pipe, and a space is formed between the first insulation blanket and the wall.

3. A pipeline transport system, including two transport pipe devices, a connection structure, a vacuum pipe, a pump, and a control unit, wherein each of the transport pipe devices is a vacuum-insulated transport pipe device according to claim 1, the transport pipe devices are arranged in sequence, the connection structure connects the adjacent inner pipes, the vacuum pipe connects each one-way valve and the pump, and the pump draws air from the interior of each chamber through the vacuum pipe; the control unit comprises primarily of electronic circuits, including two controllers, two temperature sensors, and two pressure sensors, wherein each transport pipe device is correspondingly configured with one controller, each controller is electrically connected to the electrical connection port and the one-way valve of its corresponding transport pipe device; each temperature sensor senses the temperature of each inner pipe and transmits the sensed temperature data to the respective controller and each pressure sensor senses the air pressure in each chamber and transmits the pressure data to the respective controller; each controller includes a microprocessor executing an application program, based thereon, each microprocessor controls the operating state of each electric heating structure and the pump, and the communication or blocking of each one-way valve based on the temperature data and the pressure data.

4. The pipeline transport system according to claim 3, wherein the exterior of the connection structure is covered with an insulating member.

5. The pipeline transport system according to claim 3, wherein the control unit further includes a display and an operating device, the display and the operating device are respectively coupled to each controller, the display is used to display the temperature data and the pressure data, and the operating device is mainly composed of electronic circuits and is used to operate and control each controller.
